(19) United States
(12) Patent Application Publication
(10) Pub. No.: US 2017/0372028 A1
(43) Pub. Date: Dec. 28, 2017

(54) SYSTEM AND METHOD FOR SCORING THE PERFORMANCE OF HEALTHCARE ORGANIZATIONS

(71) Applicant: XEROX CORPORATION, NORWALK, CT (US)

(72) Inventors: JING ZHOU, PITTSFORD, NY (US); MICHAEL D. SHEPHERD, ONTARIO, NY (US); DENNIS F. QUEBE, JR., AUSTIN, TX (US); JENNIE ECHOLS, CUMMING, GA (US); FAMING LI, SOLON, OH (US); LINA FU, FAIRPORT, NY (US); XUEJIN WEN, FAIRPORT, NY (US); JINHUI YAO, PITTSFORD, NY (US)

(21) Appl. No.: 15/189,859

(22) Filed: Jun. 22, 2016

(51) Int. Cl. G06F 19/00

(52) U.S. Cl. CPC G06F 19/3431; G06F 19/322; G06F 19/327

(57) ABSTRACT

A method of evaluating managed care organizations (MCOs) includes acquiring medical data associated with patients' healthcare encounters with the MCOs, calculating a health risk score of a subpopulation using patient characteristic data included in the medical data, providing encounter data included in the medical data and the health risk score as input to analytic processes that track services provided by the MCOs, and generating a risk-adjusted performance metric of the MCOs by the analytic processes. The risk-adjusted performance metrics relate to categories of concern. The method further includes generating a standardized score for each of the risk-adjusted performance metrics based on a comparison of the subpopulation with an entire population, assigning a weight to each of the standardized scores based on an importance level of each category of concern, and generating a final score corresponding to a performance category for each of the MCOs based on the standardized scores.

### BACKGROUND

### 1. Technical Field

Exemplary embodiments of the present disclosure relate to systems and methods generally related to scoring the performance of healthcare organizations, and more particularly, to systems and methods for providing scoring capabilities for tracking and managing the effectiveness of healthcare organizations.

### 2. Discussion of Related Art

Currently, there is a trend in U.S. State Medicaid offices to transition their members from a fee-for-service payment model to a managed care payment model. The Centers for Medicare and Medicaid Services (CMS) dictates that states provide better oversight of Managed Care Organizations (MCOs). Insights into patient data require automated processes so that Medicaid directors can easily understand how each MCO and healthcare provider is performing from, for example, clinical, financial, and operational perspectives. Medicaid directors need convenient ways to evaluate the performance of MCOs to improve the care of MCO members and the cost effectiveness of MCOs.

### SUMMARY

According to aspects illustrated herein, an exemplary embodiment of the present disclosure provides a computer system configured to perform a method of evaluating managed care organizations (MCOs). The system includes a memory storing a computer program, and a processor configured to execute the computer program. The computer program is configured to acquire medical data associated with patients' healthcare encounters with the MCOs. The medical data includes encounter data indicating a relation between services provided by the MCOs and the patients' healthcare encounters, and patient characteristic data indicating characteristics of the patients. The computer program is further configured to calculate a health risk score of a subpopulation using the patient characteristic data, provide the encounter data and the health risk score as input to analytic modules existing in a library of analytic modules that track the services provided by the MCOs, and generate a risk-adjusted performance metric of the MCOs by each of the analytic modules. Each of the risk-adjusted performance metrics relates to a category of concern, and the risk-adjusted performance metrics are calculated using the encounter data and the health risk score. The computer program is further configured to generate a standardized score for each of the risk-adjusted performance metrics based on a comparison of the subpopulation with an entire population, assign a weight to each of the standardized scores based on an importance level of each category of concern, and generate a final score corresponding to a performance category for each of the MCOs based on the standardized scores.

According to aspects illustrated herein, an exemplary embodiment of the present disclosure provides a method of evaluating managed care organizations (MCOs). The method includes acquiring medical data associated with patients' healthcare encounters with the MCOs. The medical data includes encounter data indicating a relation between services provided by the MCOs and the patients' healthcare encounters, and patient characteristic data indicating characteristics of the patients. The method further includes calculating a health risk score of a subpopulation using the patient characteristic data, providing the encounter data and the health risk score as input to analytic modules existing in a library of analytic modules that track the services provided by the MCOs, and generating a risk-adjusted performance metric of the MCOs by each of the analytic modules. Each of the risk-adjusted performance metrics relates to a category of concern, and the risk-adjusted performance metrics are calculated using the encounter data and the health risk score. The method further includes generating a standardized score for each of the risk-adjusted performance metrics based on a comparison of the subpopulation with an entire population, assigning a weight to each of the standardized scores based on an importance level of each category of concern, and generating a final score corresponding to a performance category for each of the MCOs based on the standardized scores.

According to aspects illustrated herein, an exemplary embodiment of the present disclosure provides a computer program product for evaluating managed care organizations (MCOs). The computer program product includes a computer readable storage medium having program instructions embodied therewith. The program instructions are executable by a processor to cause the processor to acquire medical data associated with patients' healthcare encounters with the MCOs. The medical data includes encounter data indicating a relation between services provided by the MCOs and the patients' healthcare encounters, and patient characteristic data indicating characteristics of the patients. The program instructions further cause the processor to calculate a health risk score of a subpopulation using the patient characteristic data, provide the encounter data and the health risk score as input to analytic modules existing in a library of analytic modules that track the services provided by the MCOs, and generate a risk-adjusted performance metric of the MCOs by each of the analytic modules. Each of the risk-adjusted performance metrics relates to a category of concern, and the risk-adjusted performance metrics are calculated using the encounter data and the health risk score. The program instructions further cause the processor to generate a standardized score for each of the risk-adjusted performance metrics based on a comparison of the subpopulation with an entire population, assign a weight to each of the standardized scores based on an importance level of each category of concern, and generate a final score corresponding to a performance category for each of the MCOs based on the standardized scores.

### BRIEF DESCRIPTION OF THE DRAWINGS

The above and other features of the present disclosure will become more apparent by describing in detail exemplary embodiments thereof with reference to the accompanying drawings, in which:

FIG. 1 is a block diagram of a network for communication between a computer and a database, according to exemplary embodiments of the present disclosure.

FIG. 2 is a flow diagram showing an overview of performing a method of scoring the performance of healthcare organizations according to an exemplary embodiment of the present disclosure.

FIG. 3 is an exemplary listing of scores for a plurality of Managed Care Organizations (MCOs) generated according to exemplary embodiments of the present disclosure.

FIG. 4 is a flow diagram showing a method of evaluating managed care organizations (MCOs) according to an exemplary embodiment of the present disclosure.

FIG. 5 is a schematic diagram illustrating a device used to implement exemplary embodiments of the present disclosure.

FIG. 6 is a schematic diagram illustrating a system used to implement exemplary embodiments of the present disclosure.

### DETAILED DESCRIPTION

Exemplary embodiments of the present disclosure will be described more fully hereinafter with reference to the accompanying drawings. Like reference numerals may refer to like elements throughout the accompanying drawings. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

Glossary

As used herein, the following terms are understood to have the following meanings:

member: any person enrolled in a Managed Care Organization (MCO).

healthcare provider: an entity that provides a medical service. Examples of healthcare providers include an endocrinologist providing endocrinology services, a psychiatrist providing psychiatry services, a gastroenterologist providing gastroenterology services, a dermatologist providing dermatology services, a neurologist providing neurology services, an orthopedic doctor providing orthopedics services, an ENT providing otology services, an ophthalmologist providing ophthalmology services, an oncologist providing oncology services, etc.

category of concern: a collection of character strings (e.g., words, phrases, etc.) defined by a medical domain expert corresponding to an area of interest that indicates to an MCO-monitoring organization (e.g., a Medicaid office) the effectiveness and efficiency of an

MCO being monitored. A category of concern is an area of interest that has a significant impact on both the cost of providing care and the quality of care provided by an MCO being monitored. Examples of common categories of concern include “emergency department utilization”, “hospital re-admissions”, “demographic disparity in care”, “service utilization by members with chronic conditions”, etc.

analytic module: a predefined algorithm that addresses a specific category of concern. A plurality of predefined analytic modules may be stored in a library in an electronic database. Each analytic module may receive encounter data and a health risk score as input, and may generate a risk-adjusted performance metric as output. Each risk-adjusted performance metric relates to a category of concern. The risk-adjusted performance metrics are calculated using both the raw encounter data and the health risk score received as inputs by the analytic module. Each analytic module produces a risk-adjusted performance metric as its output. This output corresponds to specific, relevant findings for the corresponding category of concern. An example of an analytic module is an analytic module that calculates the ratio of avoidable-to-non-avoidable emergency department visits for various types of members (e.g., for medium-risk members with type-2 diabetes), and outputs risk-adjusted raw measurements (e.g., MCO1 has a ratio of 22% avoidable-to-non-avoidable emergency department visits, MCO2 has a ratio of 15% avoidable-to-non-avoidable emergency department visits, MCO3 has a ratio of 17% avoidable-to-non-avoidable emergency department visits, etc.).

medical data: data associated with patients' healthcare encounters with MCOs. Medical data may include, for example, encounter data indicating a relation between services provided by the MCOs and the patients' healthcare encounters, and patient characteristic data indicating characteristics of the patients. Patient characteristic data may include, for example, demographic data, physiological data, personal medical history data, family medical history data, mental health data, lifestyle data, etc.

health risk score: a score calculated for an individual or a subpopulation that indicates the health of the individual or the subpopulation relative to an entire population. For example, considering that an MCO may be managing or treating an adverse selection of an overall population, the utilization of health risk scores allow for the effective comparison of scores of one MCO to another. Software such as, for example OPTUM's SYMMETRY, 3M APR-DRG, etc. may be utilized to calculate health risk scores.

risk-adjusted performance metrics/raw measures: data output by analytic modules. Each risk-adjusted performance metric relates to a category of concern. The risk-adjusted performance metrics are calculated using both raw encounter data and health risk scores received as inputs by the analytic module. Each analytic module produces a risk-adjusted performance metric as its output. This output corresponds to specific, relevant findings for the corresponding category of concern.

standardized scores: scores generated to correspond to the risk-adjusted performance metrics based on a comparison of the subpopulation with an entire population. Standardized scores may be obtained using, for example, principal component analysis (PCA), factor analysis, and nonnegative matrix factorization. Raw measure statistics of a whole population (e.g., a nationwide whole population, a statewide whole population, a countywide whole population, etc.) may be used as a baseline when generating standardized scores.

final score: a score corresponding to a performance category of an MCO. For example, performance categories may include categories relating to “clinical excellence”, “financial excellence”, “operational excellence”, and “customer excellence.” Each performance category may have a corresponding final score indicating an MCO's performance relating to that category.

Exemplary embodiments of the present disclosure provide systems and methods that provide healthcare-monitoring organizations (e.g., Medicaid offices), which monitor the efficiency and effectiveness of Managed Care Organizations (MCOs) and other healthcare organizations (e.g., hospitals, clinics, provider networks, etc.), with capabilities for tracking and managing the effectiveness of such MCOs and healthcare organizations.

For example, according to exemplary embodiments, a scoring system is provided that uses the output of various analytics modules (also referred to herein as risk-adjusted analytic modules) based on various types of medical data to provide easily understandable insights regarding the performance of healthcare organizations. Each analytic module generates metrics having a mean value and a desired confident interval relating to one or more factors regarding the effectiveness of each healthcare organization. The metrics are weighted and used to calculate overall scores for each healthcare organization. Each healthcare organization may then be provided with the factors that most influence its scores, both positively and negatively. A user at a healthcare-monitoring organization may subsequently use the scoring system to analyze the factors and determine recommendations to provide to the healthcare organizations to assist the healthcare organizations in improving performance. Such a recommendation may include, for example, moving a particular type of member (e.g., a member with type-2 diabetes) from one MCO to another MCO.

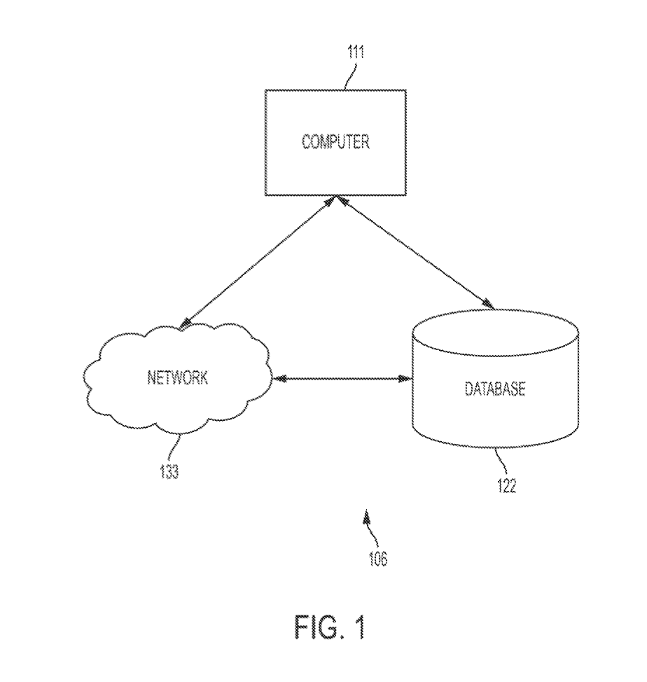

FIG. 1 shows a general overview of a network, indicated generally as 106, for communication between a computer system 111 and a database 122. The computer system 111 may include any form of processor as described in further detail below. The computer system 111 can be programmed with appropriate application software, which can be stored in a memory of the computer system 111, and which implements the methods described herein. Alternatively, the computer system 111 is a special purpose machine that is specialized for processing healthcare data and includes a dedicated processor that would not operate like a general purpose processor because the dedicated processor has application specific integrated circuits (ASICs) that are specialized for the handling of medical data processing operations (e.g., medical claims), processing analytic modules and workflows, tracking services provided by MCOs, etc. In one example, the computer system 111 is a special purpose machine that includes a specialized processing card having unique ASICs for identifying analytic modules and constructing analytic workflows, includes specialized boards having unique ASICs for input and output devices to increase the speed of network communications processing, a specialized ASIC processor that performs the logic of the methods described herein using dedicated unique hardware, logic circuits, etc.

The database 122 includes any database or any set of records or data that the computer system 111 desires to retrieve. The database 122 may be any organized collection of data operating with any type of database management system. The database 122 may contain matrices of datasets including multi-relational data elements. All libraries of data described herein may be included the database 122, or in multiple databases 122.

The database 122 may communicate with the computer system 111 directly. Alternatively, the database 122 may communicate with the computer system 111 over the network 133. The network 133 includes a communication network for affecting communication between the computer system 111 and the database 122. For example, the network 133 may include a local area network (LAN) or a global computer network, such as the Internet.

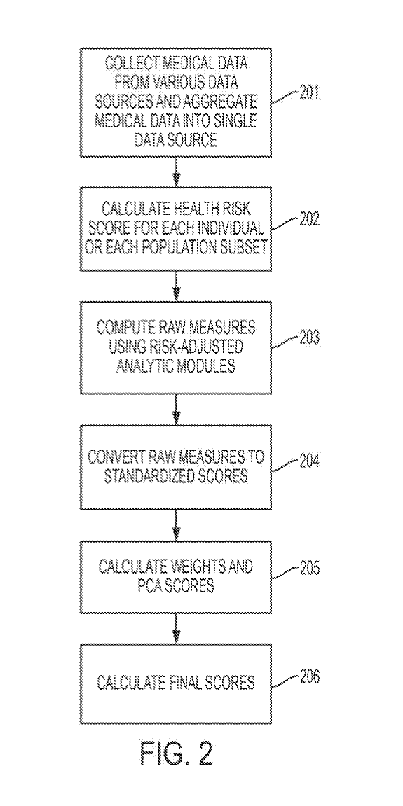

FIG. 2 is a flow diagram showing an overview of performing a method of scoring the performance of healthcare organizations according to an exemplary embodiment of the present disclosure.

At block 201, medical data may be collected from various data sources and aggregated into a single data source. The collected data is used to provide healthcare-monitoring organizations with the scoring capabilities described herein. The various data sources may include, for example, data sources maintained by Medicaid offices, insurance companies, medical institutions such as hospitals, urgent care centers, doctor's offices, etc. Examples of the types of data included in and retrieved from the various data sources include medical claim data including encounter claims (e.g., claims submitted by a healthcare provider that record services rendered by the healthcare provider), fee-for-service claims, capitation claims, member data, provider data, clinical data, lab data, disease data, risk scores, etc. Additional structured and unstructured data sources including data such as, for example, hospital data (e.g., financial data and operational data), health information exchange (HIE) data, electronic health record (EHR) data, clinical note data, compliance data, case management data, member socioeconomic data, member lifestyle data, and member feedback data may also be utilized. According to exemplary embodiments, data may be extracted from the various data sources and aggregated into a library stored at a single data source, and data from the additional structured and unstructured data sources may be processed (e.g., cleaned, indexed, classified, etc.) and incorporated into the library. This may be implemented by, for example, performing batch processing or automated inline processing. Different actors (e.g., MCO-monitoring organizations, MCOs, patients, doctors, etc.) may have different levels of access to the library, including, for example, the ability to view and/or modify data stored in the library.

At block 202, a health risk score is calculated for each individual in an overall population or for each population subset (also referred to herein as a subpopulation) in an overall population. The overall health of an individual may vary due to a variety of factors such as, for example, demographics, physiological data, personal and family medical history, mental health, lifestyle, etc. In addition, an overall population may include multiple population subsets (e.g., subpopulations) that include different types of individuals with different health situations. As a result, a healthcare organization may be managing or treating an adverse selection of an overall population. Thus, to effectively compare the scores of one organization to another, exemplary embodiments calculate the health risk score for each individual in an overall population or for each population subset in an overall population. Software such as, for example OPTUM's SYMMETRY, 3M APR-DRG, etc. may be utilized to calculate the health risk scores. Once the health risk scores are computed, the scores are used for risk adjustment during analysis.

At block 203, risk-adjusted analytic modules are used to compute raw measures. Herein, these raw measures computed by the risk-adjusted analytic modules may also be referred to as risk-adjusted performance metrics. Each risk-adjusted performance metric is related to a category of concern. For example, different healthcare-monitoring organizations have various categories of concerns that are used to closely track the effectiveness of healthcare organizations. These categories of concern typically have a significant impact on both the cost of care and the quality of care. Examples of common categories of concern include, for example, “emergency department utilization”, “hospital re-admissions”, “demographic disparity in care”, “service utilization by members with chronic conditions”, etc. Within each category of concern, an analysis of encounter claims data for that healthcare organization may lead to the identification of key quantifiable measures that contribute to that healthcare organization's positive or negative performance. The key quantifiable measures may be grouped according to different aspects of excellence such as, for example, clinical excellence, financial excellence, operational excellence, customer excellence, etc.

The analytic modules may be stored in a library in an electronic database. Each analytic module produces an output that corresponds to specific, relevant findings for the corresponding category of concern. An example of an analytic module is an analytic module that calculates the ratio of avoidable-to-non-avoidable emergency department visits for various types of members (e.g., for medium-risk members with type-2 diabetes), and outputs risk-adjusted raw measurements (e.g., MCO1 has a ratio of 22% avoidable-to-non-avoidable emergency department visits, MCO2 has a ratio of 15% avoidable-to-non-avoidable emergency department visits, MCO3 has a ratio of 17% avoidable-to-non-avoidable emergency department visits, etc.).

All measures are statistical measures such as, for example, the population average of given events. Statistical measures include uncertainty as a result of outliers significantly affecting the mean. Thus, if only the mean measurement is used for comparison between healthcare organizations, especially across small population subsets, inaccurate scoring may occur. Therefore, exemplary embodiments of the present disclosure utilize a confident interval for each raw measure. In most situations, the distribution of a measure is approximate to a normal distribution due to the central limit theorem. The confident interval may be calculated by z*sigma/sqrt(n). For more complex algorithms, the confident interval can be attained either by transformation to normal distribution using, for example, box-cox transformation, or by direct calculation if the distribution is explicitly known. Utilization of the confident interval allows for a more accurate comparison to be made between different population subsets.

At block 204, the raw measures are converted to standardized scores to provide a universal scale that can be used for benchmarking. In an exemplary embodiment, raw measure statistics of a whole population (e.g., a nationwide whole population, a statewide whole population, a countywide whole population, etc.) is used as a baseline. In many cases, an algorithm utilizing a z-score can be used to generate a standardized score with a confident interval:

Z±ΔZ=(M±ΔM−μ_{M})/SE

In the above algorithm, Z is the converted score, ±ΔZ indicates the confident interval, M is the raw measure of a population subset, ±ΔM indicates the confident interval of the raw measure, and μₘ and SE are respectively the raw measure of the whole population and its standard error. According to exemplary embodiments, more complex algorithms may be utilized as needed (e.g., when distribution is not normal) to generate the standardized score with the confident interval. If a smaller raw measure is preferred, a minus sign may be added to the conversion function.

At block 205, weights are calculated. Weights may be calculated for the first time or recalculated as needed. In addition, in exemplary embodiments, principal component analysis (PCA) component scores may be calculated as needed, as described further below. For example, different measures may have different degrees of impact toward the performance of a healthcare organization. Accordingly, a weight is assigned to each type of measure score. Weights may be preassigned or assigned by a user in real-time. In exemplary embodiments, a domain expert may predefine a weight for each measure. For example, in an exemplary scenario, a hospital readmission rate score may be assigned a weight of 2 and a hospital admission rate score may be assigned a weight of 1.

In exemplary embodiments, when different measures are independent of each other, weights can be independently assigned and weighted z-scores may be added together to obtain an overall score. However, in exemplary embodiments, certain measures may be correlated with each other (e.g., days covered by a control medication and the number of used control medication units for asthma patients), and/or new measures may be added to the system, resulting in weights being updated.

Exemplary embodiments of the present disclosure may utilize a variety of methods capable of transforming the raw measures (also referred to herein as the risk-adjusted performance metrics, which are output by the analytic algorithms) into a new set of factors (also referred to as the standardized scores). Any method capable of generating factors from raw measures may be used. Such methods include, but are not limited to, principal component analysis (PCA), factor analysis, and nonnegative matrix factorization. These methods are used to generate new factors from original high-dimensional correlated raw measures. These new factors include, for example, principal components when PCA is used, factors when factor analysis is used, and new vectors when nonnegative matrix factorization is used.

A weight may be assigned to each new factor (e.g., each converted standardized score) based on, for example, the interpretation of each factor by a domain expert. A final score may then be calculated for each MCO. In exemplary embodiments, the final score for an MCO is equal to the sum of the weighted standardized scores generated by a plurality of analytic modules that have computed standardized scores using input data corresponding to that MCO. When utilizing the above methods to transform the raw measures, each factor is a combination of raw measures, and each factor has a tangible reason providing support, which assists in the assessment of the value of the factor's weight. It is to be understood that although the exemplary embodiments described below utilize PCA, the present invention is not limited thereto. According to exemplary embodiments, time series records may be divided into segments with a desired duration (e.g., one week, one month, three months, etc.) to obtain a score per measure per population per time segment, resulting in a sufficient amount of data points for a particular analysis.

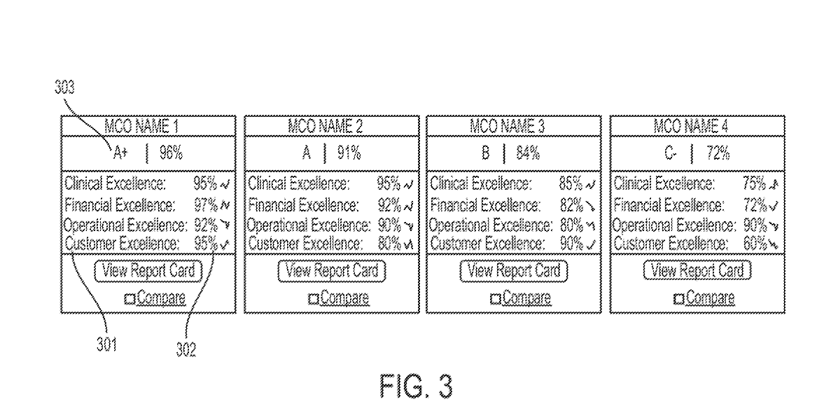

The results may be displayed in a graphical user interface (GUI). For example, the results shown in FIG. 3 may be displayed in a GUI on a monitor. Weights may be assigned to standardized scores, as described below, by a user in real-time via the GUI. In the GUI, an extra time window can be applied to focus on results in a particular period, and a slide window can be used to obtain trend analysis. Z-scores may then be resealed for all measures to have the same standard deviation and mean. In situations in which a domain expert believes some measures are independent of others and/or some measures are more or less important than others (e.g., based on either general domain knowledge or certain requirements for the present situation), different scaling factors may be applied to these measures.

As described above, once the principal components are attained, a weight may be assigned to each component, such that the new component score is equal to the component score multiplied by the weight based on each principal component. In an ideal situation, each independent principal component has a tangible reason to support it, which assists in the assessment of the appropriate value for each weight. For example, if one principal component only has significant loading in several raw measures including preventive care compliance rate, avoidable emergency visit rate, and provider to member ratio, then this principal component can be interpreted as an “access to care” component for domain experts to adjust the weight accordingly. Additional dimension reduction may be achieved by removing components associated with small eigenvalues (e.g., by setting the component's weight to 0). Based on the weights assigned to each principal component, the corresponding weights that were indirectly assigned to the original measures may be reversely calculated.

At block 206, final scores are calculated. In an exemplary embodiment, the final scores are calculated using the weighted PCA component scores (e.g., when PCA is used to obtain the standardized scores). For example, the weighted PCA component scores may be added together to obtain a final score for each of a plurality of different performance categories (e.g., clinical score category, financial score category, operational score category, customer service score category, etc.). Alternatively, the weighted original scores of original measures may be added together to obtain the final scores.

As described above, the method used to transform the raw measures into a new set of factors to obtain the standardized scores is not limited to PCA. For example, methods such as factor analysis and nonnegative matrix factorization may be used. When utilizing these methods, the factors may first be attained, and a weight may then be assigned for each factor. The score calculation process is implemented in the same manner as described above with reference to utilizing PCA.

The final scores may be shifted and scaled to obtain a desired range (e.g., 0 to 100). An exemplary listing of final scores 302 for a plurality of MCOs is shown in FIG. 3. The final scores 302 may be used to benchmark different healthcare organizations. For example, users may drill down from the final scores 302 to each component to gain insight about the performance of different healthcare organizations in relation to different categories 301. In addition, in exemplary embodiments, the best and worst measures may be automatically reported for each healthcare organization.

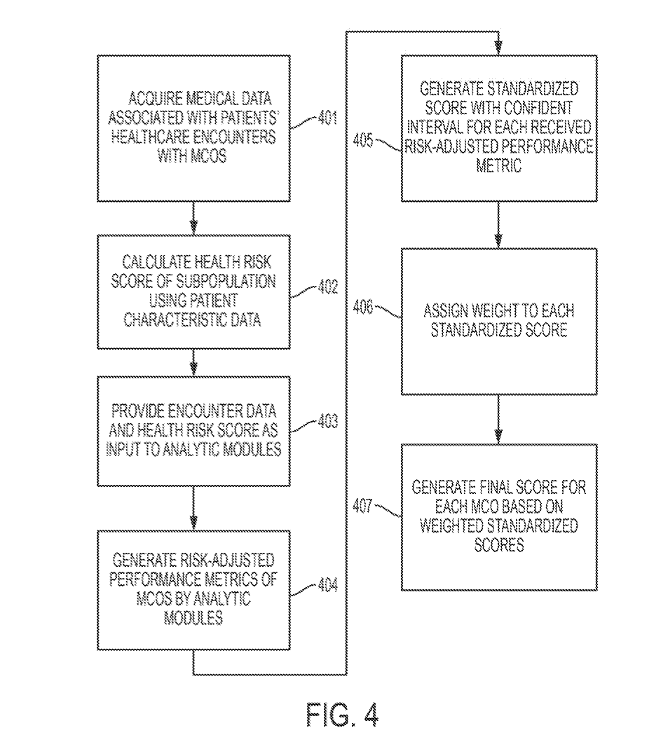

FIG. 4 is a flow diagram showing a method of evaluating managed care organizations (MCOs) according to an exemplary embodiment of the present disclosure.

At block 401, medical data associated with patients' healthcare encounters with the MCOs is acquired. The medical data may include, for example, encounter data indicating a relation between services provided by the MCOs and the patients' healthcare encounters, and patient characteristic data indicating characteristics of the patients. The patient characteristic data may include, for example, demographic data, physiological data, personal medical history data, family medical history data, mental health data, lifestyle data, etc.

At block 402, a health risk score of a subpopulation is calculated using the patient characteristic data. As described above with reference to FIG. 2, a variety of risk calculation software such as, for example, OPTUM's SYMMETRY, 3M APR-DRG, etc. may be used to calculate the health risk score. The software uses patient information included in the acquired patient characteristic data such as, for example, demographic data, physiological data, personal medical history data, family medical history data, mental health data, lifestyle data, etc. to calculate the health risk score. For example, to calculate the health risk score, a first operation may be performed in which patient information such as a diagnosis code, a drug code, a procedure code, etc., is grouped into high-level categories. A second operation may then be performed in which the high-level categories are further grouped into different diseases with different severity levels. A third operation may then be performed in which a weight is assigned to each patient based on, for example, the patient's demographic, disease(s) type, and disease(s) severity. For example, a male patient with diabetes and heart disease may receive a health risk score of 3.5 (e.g., male diabetes=1.5+male heart disease=2.0). The health risk score may be embodied in various formats as long as the same scale is used for all patients.

Regarding the weights assigned to the patients, a weight may be assigned to each patient based on his/her health risk score, and optionally, based on additional information. Using the readmission rate for an MCO as an example, a relatively lower weight is assigned to patients with a higher risk score and a relatively higher weight is assigned to patients with a lower risk score, since patients with a high risk score are generally less healthy and have a higher probability to be readmitted by hospitals. The weights assigned to a given patient for the calculation of different risk-adjusted performance metrics is not necessarily the same. For example, the weight used to calculate the adjusted readmission rate is different from the weight used to calculate adjusted preventive care compliance rate. Further, a patient's general health status may not be relevant for certain performance metrics such as, for example, prenatal care.

At block 403, the encounter data and the health risk score are provided as input to analytic modules existing in a library of analytic modules that track the services provided by the MCOs.

At block 404, each of the analytic modules provided with the encounter data and the health risk score generates a risk-adjusted performance metric of the MCOs. As described above, each of the risk-adjusted performance metrics relates to a category of concern (e.g., emergency department utilization, hospital readmissions, demographic disparity in care, chronic condition service utilization, etc.). The risk-adjusted performance metrics are calculated using both the raw encounter data and the health risk score, which are received as inputs by the analytic modules. Risk is adjusted for each patient.

At block 405, a standardized score (e.g., a z-score), which may include a confident interval, is generated for each of the received risk-adjusted performance metrics based on a comparison of the subpopulation with an entire population. As described above with reference to FIG. 2, a variety of methods capable of transforming the risk-adjusted performance metrics into the set of standardized scores may be utilized to generate the set of standardized scores. These methods include, for example, principal component analysis (PCA), factor analysis, and nonnegative matrix factorization. Using any of these methods, the original high-dimensional correlated risk-adjusted performance metrics generated by the analytic modules are used to generate the standardized scores. As described above with reference to FIG. 2, raw measure statistics of a whole population (e.g., a nationwide whole population, a statewide whole population, a countywide whole population, etc.) may be used as a baseline when generating the standardized score, and the standardized score may be generated utilizing an algorithm such as, for example:

Z±ΔZ=(M±ΔM−μₘ)/SE

At block 406, a weight is assigned to each generated standardized score. As described above, each standardized scores corresponds to a risk-adjusted performance metric generated by one of the analytic modules. Each analytic module generates a risk-adjusted performance metric relating to a category of concern such as, for example, “emergency department utilization”, “hospital re-admissions”, “demographic disparity in care”, “service utilization by members with chronic conditions”, etc. Thus, each standardized score corresponds to a category of concern.

Weights are assigned to the standardized scores based on the importance of different categories of concern in calculating scores of MCOs. The weights may be assigned by a user in real-time, or preassigned, for example, based on an interpretation made by a domain expert. The weights are assigned based on domain knowledge and/or business requirements. For example, when scoring the performance of MCOs, it may be determined based on certain business requirements that greater importance is placed on “hospital re-admissions” than “emergency department utilization”, and weights may be assigned accordingly (e.g., weights may be assigned to each standardized score based on an importance level of the corresponding category of concern). Thus, weights can be assigned by a user based on which categories of concern are most important to the user. For example, consider the following equation:

Y=a1*x1+a2*x2

In the above equation, Y represents a final score of an MCO, x1 represents a standardized score of the MCO corresponding to a first category of concern (e.g., “hospital readmissions”), x2 represents a standardized score of the MCO corresponding to a second category of concern (e.g., “emergency department utilization”), a1 represents a weight assigned to x1, and a2 represents a weight assigned to x2. Depending on certain business requirements, “hospital readmissions” may be more important than “emergency department utilization” when generating a final score of the MCO. Thus, a user may assign a larger weight to “hospital readmissions” than to “emergency department utilization” (e.g., a1>a2). Thus, in an exemplary embodiment, the final score Y is a weighted sum of all standardized scores generated for an MCO. Weights may be assigned differently based on different business requirements. Thus, in another scenario, a user may assign the weights such that a2>a1.

At block 407, a final score (e.g., a final score 302 for a performance category 301 as shown in FIG. 3) is generated for each of the MCOs based on the weighted standardized scores. As described above with reference to FIG. 2, the final score 302 for an MCO may be equal to the sum of the weighted standardized scores generated by the plurality of analytic modules that have computed standardized scores using input data corresponding to that MCO. For example, a plurality of data (e.g., a plurality of different encounter data and health risk data) corresponding to patients of one MCO may be input to a plurality of analytic modules, which output different risk-adjusted performance metrics corresponding to different categories of concern. These different risk-adjusted performance metrics are weighted and summed together to obtain a final score 302 for a performance category 301 for the corresponding MCO.

In an exemplary embodiment, a threshold weight value may be set. The threshold weight value may be predefined (e.g., by a domain expert) or defined by a user (e.g., in real-time). Weights assigned to each standardized score may be compared to the threshold weight value. If a weight is lower than the threshold weight value, the corresponding standardized score may be ignored when generating the final score 302. That is, only standardized scores having an assigned weight higher than the threshold weight value may be considered when generating the final score 302.

In an exemplary embodiment, calculating the health risk score of the subpopulation includes separately calculating an individual health risk score of each patient in the subpopulation, in which the health risk score of the subpopulation is an average of the calculated individual health risk scores.

As described above, in an exemplary embodiment, a method of evaluating the MCOs includes categorizing each of the standardized scores into one of a plurality of categories (301 in FIG. 3), and generating a final score (302 in FIG. 3) corresponding to each of the categories 301 based on the standardized scores in the respective categories 302. The performance categories 301 may include, but are not limited to, a clinical score category, a financial score category, an operational score category, and a customer service score category. An overall score (303 in FIG. 3) may then be computed for each MCO based on that MCO's final category scores 302. The overall score 303 may include, for example, a percentage grade and/or a letter grade, as shown in FIG. 3.

Aspects of the present disclosure are described herein with reference to flowchart illustrations and/or block diagrams of methods, apparatuses (systems), and computer program products according to various systems and methods. It will be understood that each block of the flowchart illustrations and/or block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to further systems and methods herein, an article of manufacture is provided that includes a tangible computer readable medium having computer readable instructions embodied therein for performing the steps of the computer implemented methods, including the methods described above. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination thereof.

Any of these devices may have computer readable instructions for carrying out the operations of the methods described above.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

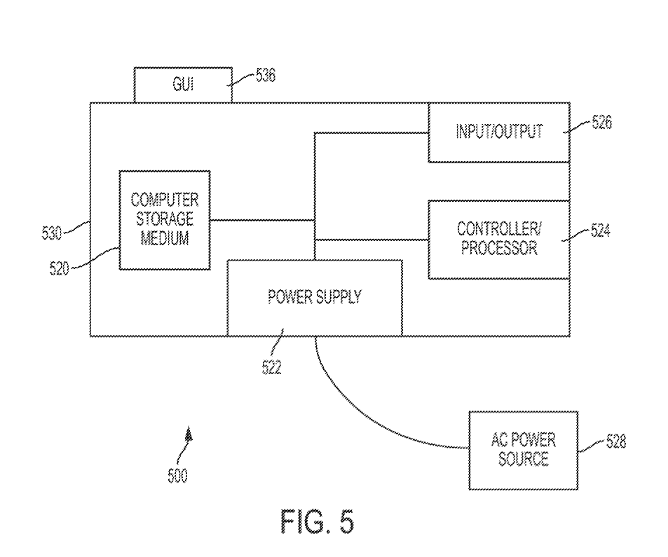

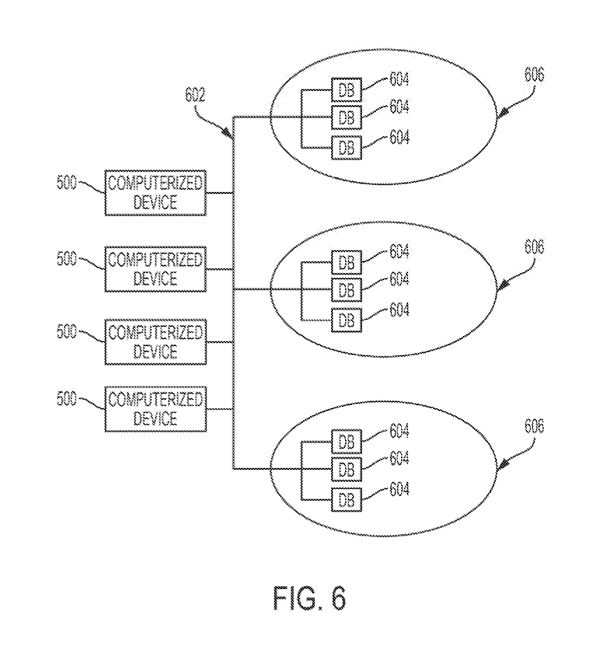

FIG. 5 illustrates a computerized device 500, which can be used with systems and methods herein and include, for example, a personal computer, a portable computing device, etc. The computerized device 500 includes a controller/processor 524 and a communications port (input/output device 526) operatively connected to the controller/processor 524. The controller/processor 524 may also be connected to a computerized network 602 external to the computerized device 500, such as shown in FIG. 6. In addition, the computerized device 500 can include at least one accessory functional component, such as a graphic user interface (GUI) assembly 536 that also operates on the power supplied from the external power source 528 (through the power supply 522).

The input/output device 526 is used for communications to and from the computerized device 500. The controller/processor 524 controls the various actions of the computerized device. A non-transitory computer storage medium 520 (which can be optical, magnetic, capacitor based, etc.) is readable by the controller/processor 524 and stores instructions that the controller/processor 524 executes to allow the computerized device 500 to perform its various functions, such as those described herein. Thus, as shown in FIG. 5, a body housing 530 has one or more functional components that operate on power supplied from the external power source 528, which may include an alternating current (AC) power source, to the power supply 522. The power supply 522 can include a power storage element (e.g., a battery) and connects to an external power source 528. The power supply 522 converts the external power into the type of power needed by the various components.

The computerized device 500 may be used to provide a graphical user interface (GUI) to the user that implements the methods described herein.

In case of implementing the systems and methods herein by software and/or firmware, a program constituting the software may be installed into a computer with dedicated hardware, from a storage medium or a network, and the computer is capable of performing various functions with various programs installed therein.

In the case where the above-described series of processing is implemented with software, the program that constitutes the software may be installed from a network such as the Internet or a storage medium such as the removable medium.

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.), or a system combining software and hardware aspects that may all generally be referred to herein as a ‘circuit’, ‘module’, or ‘system.’ Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein.

Program code embodied on a computer readable medium may be transmitted using any appropriate medium, including, but not limited to, wireless, wireline, optical fiber cable, RF, etc., or any suitable combination thereof. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various devices and methods herein. In this regard, each block in the flowchart or block diagrams may represent a module, segment, or portion of code, which includes one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

As shown in FIG. 6, exemplary systems and methods herein may include various computerized devices 500 and databases 604 located at various different physical locations 606. The computerized devices 500 and databases 604 are in communication (operatively connected to one another) by way of a local or wide area (wired or wireless) computerized network 602. The various electronic databases and libraries described above may be included in one or more of the databases 604.

The terminology used herein is for the purpose of describing particular examples of the disclosed systems and methods and is not intended to be limiting of this disclosure. For example, as used herein, the singular forms ‘a’, ‘an’, and ‘the’ are intended to include the plural forms as well, unless the context clearly indicates otherwise. Additionally, as used herein, the terms ‘includes’ and ‘including’, when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user), one or more machines perform the process without further input from any user.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, or a combination thereof.

What is claimed is:

1. A computer system configured to perform a method of evaluating managed care organizations (MCOs), the system comprising:
a memory storing a computer program; and
a processor configured to execute the computer program, wherein the computer program is configured to:
acquire medical data associated with patients' healthcare encounters with the MCOs, wherein the medical data comprises encounter data indicating a relation between services provided by the MCOs and the patients' healthcare encounters, and patient characteristic data indicating characteristics of the patients;
calculate a health risk score of a subpopulation using the patient characteristic data;
provide the encounter data and the health risk score as input to analytic modules existing in a library of analytic modules that track the services provided by the MCOs;
generate a risk-adjusted performance metric of the MCOs by each of the analytic modules, wherein each of the risk-adjusted performance metrics relates to a category of concern, and the risk-adjusted performance metrics are calculated using the encounter data and the health risk score;
generate a standardized score for each of the risk-adjusted performance metrics based on a comparison of the subpopulation with an entire population;
assign a weight to each of the standardized scores based on an importance level of each category of concern; and
generate a final score corresponding to a performance category for each of the MCOs based on the standardized scores.

2. The computer system of claim 1, wherein the computer program is further configured to:
compare each assigned weight to a threshold weight value, wherein each final score is equal to a sum of only the corresponding weighted standardized scores having an assigned weight higher than the threshold weight value.

3. The computer system of claim 1, wherein the weights are assigned in real-time by a user via a graphical user interface (GUI).

4. The computer system of claim 1, wherein the weights are preassigned by a domain expert.

5. The computer system of claim 1, wherein the computer program is configured to calculate the health risk score of the subpopulation by separately calculating an individual health risk score of each patient in the subpopulation, wherein the health risk score of the subpopulation is an average of the calculated individual health risk scores.

6. The computer system of claim 1, wherein the computer program is further configured to:
generate an overall score for each of the MCOs based on a plurality of final scores corresponding to a plurality of performance categories, wherein the generated final score is one of the plurality of final scores.

7. The computer system of claim 6, wherein the plurality of performance categories comprise at least one of a clinical score category, a financial score category, an operational score category, and a customer service score category.

8. The computer system of claim 1, wherein the standardized score is a z-score.

9. The computer system of claim 1, wherein the category of concern comprises one of emergency department utilization, hospital readmissions, demographic disparity in care, and chronic condition service utilization.

10. The computer system of claim 1, wherein the characteristic data comprises at least one of demographic data, physiological data, personal medical history data, family medical history data, mental health data, and lifestyle data.

11. The computer system of claim 1, wherein the standardized scores are generated using principal component analysis (PCA).

12. The computer system of claim 1, wherein the standardized scores are generated using one of factor analysis and nonnegative matrix factorization.

13. The computer system of claim 1, wherein each standardized score includes a confident interval.

14. The computer system of claim 1, wherein each final score is equal to a sum of the corresponding weighted standardized scores.

15. A method of evaluating managed care organizations (MCOs), comprising:
acquiring medical data associated with patients' healthcare encounters with the MCOs, wherein the medical data comprises encounter data indicating a relation between services provided by the MCOs and the patients' healthcare encounters, and patient characteristic data indicating characteristics of the patients;
calculating a health risk score of a subpopulation using the patient characteristic data;
providing the encounter data and the health risk score as input to analytic modules existing in a library of analytic modules that track the services provided by the MCOs;
generating a risk-adjusted performance metric of the MCOs by each of the analytic modules, wherein each of the risk-adjusted performance metrics relates to a category of concern, and the risk-adjusted performance metrics are calculated using the encounter data and the health risk score;
generating a standardized score for each of the risk-adjusted performance metrics based on a comparison of the subpopulation with an entire population;
assigning a weight to each of the standardized scores based on an importance level of each category of concern; and
generating a final score corresponding to a performance category for each of the MCOs based on the standardized scores.

16. The method of claim 15, further comprising:
comparing each assigned weight to a threshold weight value, wherein each final score is equal to a sum of only the corresponding weighted standardized scores having an assigned weight higher than the threshold weight value.

17. The method of claim 15, wherein calculating the health risk score of the subpopulation comprises:
separately calculating an individual health risk score of each patient in the subpopulation, wherein the health risk score of the subpopulation is an average of the calculated individual health risk scores.

18. A computer program product for evaluating managed care organizations (MCOs), the computer program product comprising a computer readable storage medium having program instructions embodied therewith, the program instructions executable by a processor to cause the processor to:
acquire medical data associated with patients' healthcare encounters with the MCOs, wherein the medical data comprises encounter data indicating a relation between services provided by the MCOs and the patients' healthcare encounters, and patient characteristic data indicating characteristics of the patients;
calculate a health risk score of a subpopulation using the patient characteristic data;
provide the encounter data and the health risk score as input to analytic modules existing in a library of analytic modules that track the services provided by the MCOs;
generate a risk-adjusted performance metric of the MCOs by each of the analytic modules, wherein each of the risk-adjusted performance metrics relates to a category of concern, and the risk-adjusted performance metrics are calculated using the encounter data and the health risk score;
generate a standardized score for each of the risk-adjusted performance metrics based on a comparison of the subpopulation with an entire population;
assign a weight to each of the standardized scores based on an importance level of each category of concern; and
generate a final score corresponding to a performance category for each of the MCOs based on the standardized scores.

19. The computer program product of claim 18, wherein the program instructions further cause the processor to:
compare each assigned weight to a threshold weight value, wherein each final score is equal to a sum of only the corresponding weighted standardized scores having an assigned weight higher than the threshold weight value.

20. The computer program product of claim 18, wherein the processor is configured to calculate the health risk score of the subpopulation by separately calculating an individual health risk score of each patient in the subpopulation, wherein the health risk score of the subpopulation is an average of the calculated individual health risk scores.
